(19) United States
(12) Patent Application Publication
(10) Pub. No.: US 2026/0192440 A1
(43) Pub. Date: Jul. 9, 2026

(54) Six-limb five-degree-of-freedom parallel machining robot

(71) Applicant: TIANJIN UNIVERSITY, Tianjin (CN)

(72) Inventors: Tao Sun, Tianjin (CN); Kaixuan Chen, Tianjin (CN); Panfeng Wang, Tianjin (CN); Yimin Song, Tianjin (CN); Binbin Lian, Tianjin (CN)

(21) Appl. No.: 18/873,557

(22) PCT Filed: Jun. 29, 2023
(86) PCT No.: PCT/CN2023/103881

§ 371 Date: Dec. 10, 2024

(30) Foreign Application Priority Data
Nov. 16, 2022 (CN) 202211430915.7
Nov. 16, 2022 (CN) 202211430961.7
Nov. 16, 2022 (CN) 202211433928.X

(51) Int. Cl. B25J 9/00; B25J 11/00; B25J 18/02

(52) U.S. Cl. CPC B25J 9/0048; B25J 11/005; B25J 18/02

(57) ABSTRACT

The present invention discloses a six-limb five-degree-of-freedom parallel machining robot. The parallel machining robot includes a fixed base as basis of assembly, a limb group for pose adjustment, and a moving platform as output assembly. A motor spindle as an output unit is set in the moving platform. The limb group includes an unconstrained limb sub-group and a sixth limb movably connected with the fixed base. The parallel machining robot includes six limbs, the unconstrained branched strain sub-group is able to realize the installation of the five-degree-of-freedom parallel machining robot and is lower in cost. The sixth limb is a constrained limb. Under the constraint of the sixth limb, by controlling the extension and contraction of five unconstrained branched strains, the five-degree-of-freedom motion of the moving platform is achieved. The parallel machining robot includes six parallel limbs and has high rigidity. Through the sixth limb, the output assembly has large workspace. Therefore, the six-limb five-degree-of-freedom parallel machining robot provided by the present invention has advantages of high rigidity, good flexibility, large workspace and low cost.

### BACKGROUND OF THE PRESENT INVENTION

### Field Of Invention

The present invention relates to the field of machining robot technology, and more particularly to a six-limb five-degree-of-freedom parallel machining robot.

### Description of Related Arts

At present, processing robots play an important role in the manufacturing industry, and especially in the manufacturing of core components with spatial free-form surface characteristics and complex structural parts in key equipment in the field of high technology. The advanced manufacturing industry has an increasing demand for the processing of curved complex surfaces and components with large dynamic loads, such as steel structural parts and aerospace components. Therefore, it is inevitable for the development of key industries to design and develop a high-performance robot with five-axis processing capability.

Currently, most of five-degree-of-freedom machining robots have some deficiencies as follows.
(1) Insufficient flexibility. Chinese Patent No. CN 113319828 A discloses a five-degree-of-freedom parallel machining robot. Due to the layout characteristics of the parallel machining robot disclosed by CN 113319828 A, the swing range of the end-effecter is limited. Therefore, it is difficult for the parallel machining robot disclosed by CN 113319828 A to meet the efficient machining of complex surfaces.
(2) Small workspace. Chinese Patent No. CN 102490187 A discloses a five-degree-of-freedom parallel machining robot. Due to the layout characteristics of the parallel machining robot disclosed by CN 102490187 A, the swing range of the end-effecter is limited. Therefore, it is difficult for the parallel machining robot disclosed by CN 102490187 A to meet the efficient machining of large structural parts.
(3) High cost in motor. Chinese Patent No. CN103753235 B discloses a five-degree-of-freedom parallel machining robot. Because the drive pair is a hollow brushless motor, the parallel machining robot disclosed by CN103753235 B is high in cost.

In order to solve the above problems of the five-degree-of-freedom parallel machining robot, better meet the processing needs of large and complex parts, it is urgent to invent a five-degree-of-freedom parallel machining robot with high rigidity, high precision, good flexibility, large workspace and low cost, and to propose a high efficient and high quality machining solution for complex surface structural parts in high-tech equipment.

### SUMMARY OF THE PRESENT INVENTION

An object of the present invention is to provide a six-limb five-degree-of-freedom parallel machining robot, so as to solve the problems of the prior art.

The present invention provides technical solutions as follows.

A six-limb five-degree-of-freedom parallel machining robot comprises a fixed base as basis of assembly, a limb group for pose adjustment, and a moving platform as output assembly, wherein a motor spindle as an output unit is set in the moving platform; the limb group comprises an unconstrained limb sub-group and a sixth limb movably connected with the fixed base.

Preferably, the moving platform comprises a first moving sub-platform, a second moving sub-platform fixed with the first moving sub-platform, and a third moving sub-platform fixed with the second moving sub-platform.

Preferably, the unconstrained limb sub-group comprises an upper limb and a middle limb, wherein a top portion of all of the upper limb, the middle limb and the sixth limb is in a three-layer connection with the moving platform for the pose adjustment of the motor spindle.

Preferably, one end of the upper limb is in joint connection with an outer wall of the first moving sub-platform, and another end of the upper limb is in joint with the fixed base.

Preferably, one end of the middle limb is in joint connection with an outer wall of the second moving sub-platform, and another end of the middle limb is in joint connection with the fixed base.

Preferably, the joint connection is spherical hinged connection or Hook joint connection.

Preferably, both of the upper limb and the middle limb have a first sliding pair, and the first sliding pair is able to drive the upper limb or the middle limb to extend and contract along a length direction thereof.

Preferably, the sixth limb is connected with the fixed base through a third sliding pair, and a moving direction of the third sliding pair is parallel to the fixed base;
the sixth limb has a first revolute pair, an axial direction of a rotation shaft of the first revolute pair is parallel to the moving direction of the third sliding pair;
the sixth limb has a second sliding pair, one end of the second sliding pair is connected with the first revolute pair, and another end of the second sliding pair is connected with a second Hook joint.

Preferably, the sixth limb is connected with the fixed base through the second sliding pair, and a moving direction of the second sliding pair is perpendicular to an end plane of the fixed base;
the second sliding pair comprises a pair of support seats which are set on the fixed base, and two installation sides of the pair of support seats are opposite to each other;
two sliding bases are respectively set at the two installation sides of the pair of support seats, two sliding units are respectively set on the two sliding bases and are capable of moving upwards and downwards along the two sliding bases, and the sliding units drive the sixth limb to move upwards and downwards in a direction perpendicular to the fixed base.

Preferably, the sixth limb is movably connected with the fixed base through a third Hook joint, and the sixth limb rotates at an angle with the fixed base;
the fixed base has a rotation fit structure to provide support for rotation of the sixth limb;
the third Hook joint is connected with a retractable end of the second sliding pair, and the second sliding pair is set in a limb rod.

The present invention has some beneficial effects as follows.

The parallel machining robot provided by the present invention comprises six limbs, the unconstrained branched strain sub-group is able to realize the installation of the five-degree-of-freedom parallel machining robot and is lower in cost, and the sixth limb is a constrained limb. Under the constraint of the sixth limb, by controlling the extension and contraction of five unconstrained limbs, the five-degree-of-freedom motion of the moving platform is achieved.

The parallel machining robot provided by the present invention comprises six parallel limbs, and has high rigidity. The unconstrained branched strains are independently connected with the output assembly for realizing the variation of six-degree-of-freedom of the output assembly in space. Moreover, the output assembly is connected with the sixth limb through the second Hook joint, so that the output assembly has good flexibility. Through the sixth limb, the output assembly has large workspace. Therefore, the six-limb five-degree-of-freedom parallel machining robot provided by the present invention has advantages of high rigidity, good flexibility, large workspace and low cost.

### BRIEF DESCRIPTION OF THE DRAWINGS

FIG. 1 is a structural diagram of a six-limb five-degree-of-freedom parallel machining robot according to a first example of a first embodiment of the present invention.

FIG. 2 is a structural diagram of a first limb according to the first embodiment of the present invention.

FIG. 3 is another structural diagram of the first limb according to the first embodiment of the present invention.

FIG. 4 is a structural diagram of a sixth limb according to the first embodiment of the present invention.

FIG. 5 is a structural diagram of a six-limb five-degree-of-freedom parallel machining robot according to a second example of the first embodiment of the present invention.

FIG. 6 is a structural diagram of a six-limb five-degree-of-freedom parallel machining robot according to a third example of the first embodiment of the present invention.

FIG. 7 is a structural diagram of a six-limb five-degree-of-freedom parallel machining robot according to a first example of a second embodiment of the present invention.

FIG. 8 is a structural diagram of a sixth limb according to the second embodiment of the present invention.

FIG. 9 is a structural diagram of a six-limb five-degree-of-freedom parallel machining robot according to a second example of the second embodiment of the present invention.

FIG. 10 is a structural diagram of a six-limb five-degree-of-freedom parallel machining robot according to a first example of a third embodiment of the present invention.

FIG. 11 is a structural diagram of a sixth limb according to the third embodiment of the present invention.

FIG. 12 is another structural diagram of the sixth limb according to the third embodiment of the present invention.

FIG. 13 is a structural diagram of a six-limb five-degree-of-freedom parallel machining robot according to a second example of the third embodiment of the present invention.

FIG. 14 is a structural diagram of a six-limb five-degree-of-freedom parallel machining robot according to a third example of the third embodiment of the present invention.

FIG. 15 is a structural diagram of a six-limb five-degree-of-freedom parallel machining robot according to a fourth example of the third embodiment of the present invention.

In the drawings, 1: fixed base; 2: motor spindle; 3: moving platform; 4: spherical hinge; 31: first moving sub-platform; 32: second moving sub-platform; 33: third moving sub-platform; L1: first limb; L2: second limb; L3: third limb; L4: fourth limb; L5: fifth limb; L6: sixth limb; P1: first sliding pair; P2: second sliding pair; P3: third sliding pair; R1:
first revolute pair; U1: first Hook joint; U2: second Hook joint; U3: third Hook joint.

### DETAILED DESCRIPTION OF THE PREFERRED EMBODIMENT

The present invention is described in detail with reference to accompanying drawings and embodiments as follows.

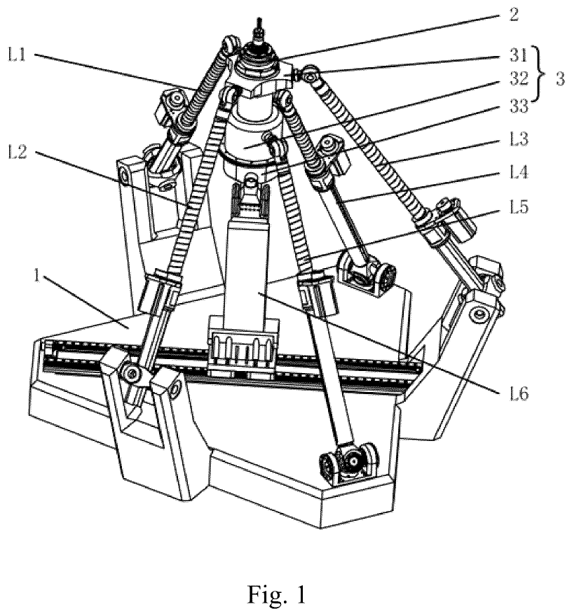

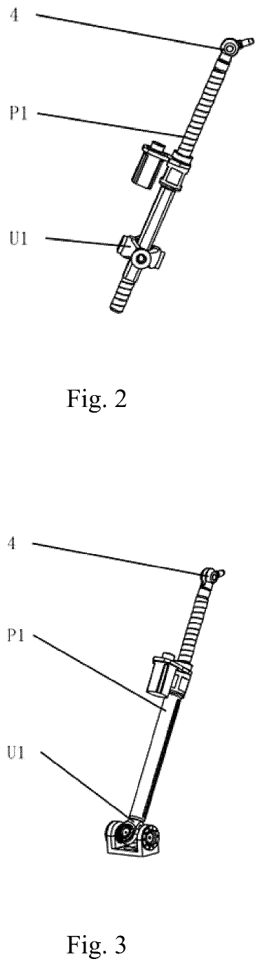

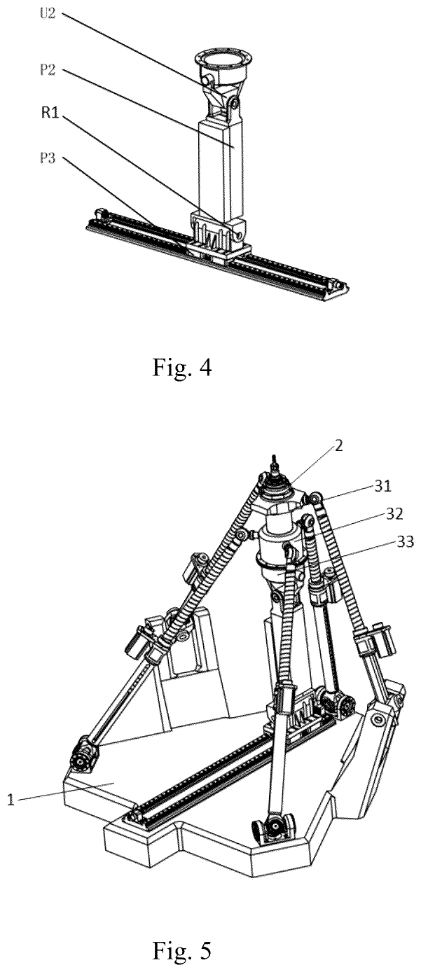

Referring to FIGS. 1 to 15, a six-limb five-degree-of-freedom parallel machining robot is illustrated. The parallel machining robot comprises a fixed base 1 as the basis of assembly, a limb group for pose adjustment, a moving platform 3 as output assembly, wherein a motor spindle 2 as an output unit is set in the moving platform 3; the limb group comprises an unconstrained limb sub-group and a sixth limb movably connected with the fixed base 1.

The moving platform 3 comprises a first moving sub-platform 31, a second moving sub-platform 32 fixed with the first moving sub-platform 31, and a third moving sub-platform 33 fixed with the second moving sub-platform 32.

The unconstrained limb sub-group comprises an upper limb and a middle limb, wherein a top portion of all of the upper limb, the middle limb and the sixth limb form a three-layer connection with the moving platform 3 for the pose adjustment of the motor spindle 2.

One end of the upper limb is in joint connection with an outer wall of the first moving sub-platform 31, and another end of the upper limb is in joint connection with the fixed base 1.

One end of the middle limb is in joint connection with an outer wall of the second moving sub-platform 32, and another end of the middle limb is in joint connection with the fixed base 1.

The joint connection is spherical hinged connection or Hook joint connection.

Both the upper limb and the middle limb have a first sliding pair, and the first sliding pair is able to drive the upper limb or the middle limb to extend and contract along a length direction thereof.

The sixth limb is connected with the fixed base 1 through a third sliding pair, and a moving direction of the third sliding pair is parallel to the fixed base 1;
the sixth limb has a first revolute pair, an axial direction of a rotation shaft of the first revolute pair is parallel to the moving direction of the third sliding pair;
the sixth limb has a second sliding pair, one end of the second sliding pair is connected with one end of the first revolute pair, and another end of the first revolute pair is connected with a second Hook joint.

The sixth limb is connected with the fixed base 1 through the second sliding pair, and a moving direction of the second sliding pair is perpendicular to an end plane of the fixed base 1;
the second sliding pair comprises a pair of support seats which are set on the fixed base 1, and two installation sides of the pair of support seats are opposite to each other;
two sliding bases are respectively set at the two installation sides of the pair of support seats, two sliding units are respectively set on the two sliding bases and are capable of moving upwards and downwards along the two sliding bases, and the sliding units drive the sixth limb to move upwards and downwards in a direction perpendicular to the fixed base 1.

The sixth limb is movably connected with the fixed base 1 through a third Hook joint, and the sixth limb rotates at an angle with the fixed base 1;
the fixed base 1 has a rotation fit structure to provide support for rotation of the sixth limb;
the third Hook joint is connected with a retractable end of the second sliding pair, and the second sliding pair is set in a limb rod.

Referring to FIGS. 1 to 6, a six-limb five-degree-of-freedom parallel machining robot according to a first embodiment is illustrated.

The parallel machining robot comprises a fixed base 1 as the basis of assembly, a limb group for pose adjustment, and a moving platform 3 as output assembly, wherein a motor spindle 2 as an output unit is set in the moving platform 3; the limb group comprises an unconstrained limb sub-group and a sixth limb L6, the sixth limb L6 is connected with the fixed base 1 through a third sliding pair P3, and a movement direction of the third sliding pair is parallel to the fixed base.

The moving platform 3 comprises a first moving sub-platform 31, a second moving sub-platform 32 fixed with the first moving sub-platform 31, and a third moving sub-platform 33 fixed with the second moving sub-platform 32.

The sixth limb has a first revolute pair R1, an axial direction of a rotation shaft of the first revolute pair R1 is parallel to the moving direction of the third sliding pair P3.

The sixth limb L6 has a second sliding pair P2, one end of the second sliding pair P2 is connected with the first revolute pair R1, and another end of the second sliding pair P2 is connected with a second Hook joint U2.

The second Hook joint U2 is movably hinged with the third moving sub-platform 33 of the moving platform 3.

The unconstrained limb sub-group comprises an upper limb and a middle limb, wherein a top portion of all of the upper limb, the middle limb and the sixth limb is in a multi-layer movable connection with the moving platform 3.

One end of the upper limb is in joint connection with an outer wall of the first moving sub-platform 31, and another end of the upper limb is in joint connection with the fixed base 1.

One end of the middle limb is in joint connection with an outer wall of the second moving sub-platform 32, and another end of the middle limb is in joint connection with the fixed base 1.

The joint connection is spherical hinged connection or Hook joint connection.

Both the upper limb and the middle limb have a first sliding pair P1, and the first sliding pair P1 is able to drive the upper limb or the middle limb to extend and contract along a length direction thereof.

Specifically, the sixth limb L6 is configured to adjust a lower end of the moving platform 3; the unconstrained limb sub-group is configured to provide joint support for an outer wall of the moving platform 3; the sixth limb L6 and the unconstrained limb sub-group are combined to adjust the pose of the moving platform 3.

Specifically, the motor spindle 2 is fixed with the moving platform 3 for the pose adjustment of the combination of the sixth limb L6 and the unconstrained limb sub-group on the motor spindle 2.

The output unit of the present invention is able to be but is not limited to the motor spindle 2.

Specifically, the first moving sub-platform 31, the second moving sub-platform 32 and the third moving sub-platform 33 are separately fixed or integrally formed.

Specifically, the outer wall of the first moving sub-platform 31 and the outer wall of the second moving sub-platform 32 have assembly holes for assembling the upper limb and the middle limb respectively.

Specifically, the upper limb comprises three limbs, two of the three limbs are symmetrical to each other left and right relative to the third sliding pair on the fixed base 1, the remaining one of the three limbs is provided at an extended line of the third sliding pair on the fixed base 1.

Specifically, the unconstrained limb sub-group comprises a first limb L1, a second limb L2, a third limb L3, a fourth limb L4 and a fifth limb L5.

Specifically, a sliding base of the third sliding pair P3 is set on the fixed base 1.

### First Example of First Embodiment

Referring to FIGS. 1 to 4, a six-limb five-degree-of-freedom parallel machining robot is illustrated, the parallel machining robot comprises a fixed base 1, a motor spindle 2, a moving platform 3, a first limb L1, a second limb L2, a third limb L3, a fourth limb L4, a fifth limb L5 and a sixth limb L6.

As shown in FIGS. 1 to 3, two ends of all of the first limb L1, the second limb L2, the third limb L3, the fourth limb L4, the fifth limb L5 and the sixth limb L6 are connected with the fixed base 1 and the moving platform 3, respectively. The moving platform 3 comprises a first moving sub-platform 31, a second moving sub-platform 32 and a third moving sub-platform 33, wherein every two adjacent moving sub-platforms are fixed with each other, and the motor spindle 2 is fixed in the moving platform 3, so that the five-degree-of-freedom parallel machining robot is formed.

Specifically, each of the first limb L1, the second limb L2, the third limb L3, the fourth limb L4, and the fifth limb L5 comprises a first sliding pair P1, a spherical hinge 4 and a first Hook joint U1, wherein the first sliding pair P1 is arranged between the spherical hinge 4 and the first Hook joint U1.

Specifically, the sixth limb L6 comprises a second sliding pair P2, a third sliding pair P3, a second Hook joint U2 and a first revolute pair R1, wherein the second sliding pair P2 is arranged between the second Hook joint U2 and the revolute pair 5, and the third sliding pair P3 is arranged between the second sliding pair P2 and the fixed base 1.

Specifically, the parallel machining robot comprises six limbs, wherein five of the six limbs are unconstrained limbs, that is, the first limb L1, the second limb L2, the third limb L3, the fourth limb L4, and the fifth limb L5; one end of the unconstrained limbs is connected with the fixed base 1 through the first Hook joint U1 or the spherical hinge 4, and accordingly, another end of the unconstrained limbs is connected with the moving platform 3 through the spherical hinge 4 or the first Hook joint U1; the first sliding pair P1 is arranged between the spherical hinge 4 and the first Hook joint U1; the sixth limb is a constrained limb, one end of the constrained limb is connected with the fixed base 1 through the third sliding pair P3, another end of the constrained limb is connected with the moving platform 3 through the second Hook joint U2.

Specifically, the unconstrained limbs are divided into two categories of an upper limb and a middle limb. The upper limb comprises the first limb L1, the second limb L2 and the third limb L3. The specific structure of each limb of the upper limb is shown in the drawings. The middle limb comprises the fourth limb L4 and the fifth limb L5. The specific structure of each limb of the middle limb is shown in the drawings. Three upper joints of the upper limb are circumferentially spacedly arranged at the first moving sub-platform 31 which is close to a head end of the motor spindle 2, and three lower joints of the upper limb are respectively connected with three protrusions protruding upwards from a circumference of the fixed base 1, so that the upper limb forms a triangular layout connection. Two upper joints of the middle limb are circumferentially spacedly arranged at the second moving sub-platform 32, and two lower joints of the middle limb are circumferentially spacedly arranged at a lower portion of the fixed base 1. The second Hook joint U2 of the sixth limb is movably connected with the third moving sub-platform 33.

Specifically, an outer wall of the fixed base 1 extends outwards for forming three support seats, a sliding base of the third sliding pair P3 is opposite to one of the three support seats, and other two of the three support seats are symmetrically provided relative to the sliding base.

Specifically, the two lower joints of the fourth limb L4 and the fifth limb L5 are symmetrically set relative to the sliding base of the third sliding pair P3.

Specifically, the unconstrained limbs are independently driven by a motor, that is, the first sliding pair P1 of each of the first limb L1, the second limb L2, the third limb L3, the fourth limb LA and the fifth limb L5 is independently driven by the motor for completing the stretching motion; the spherical hinge 4 and the first Hook joint U1 which are respectively connected with two ends of the first sliding pair P1 cooperate with the first sliding pair P1 for completing the predetermined pose of the moving platform 3. The second sliding pair P2 and the third sliding pair P3 of the sixth limb L6 complete the sliding motion with the movement of the moving platform 3; the second Hook joint U2 and the first revolute pair R1 which are respectively connected with two ends of the second sliding pair P2 also cooperate with the second sliding pair P2 for satisfying the geometric relationship of the kinematic pair of the sixth limb L6 under the predetermined pose of the moving platform 3. As as result, the five-degree-of-freedom motion of the moving platform 3 is achieved.

The first sliding pair P1 of each of the first limb L1, the second limb L2 and the third limb L3 has a hollow sleeve structure, and a retractable rod forming the first sliding pair P1 is always kept at a certain distance from the ground.

### Second Example of First Embodiment

As shown in FIG. 5, a six-limb five-degree-of-freedom parallel machining robot is illustrated, the parallel machining robot provided by the second example is the same as that provided by the first example in form of motion, the structure of the kinematic pairs and the limbs provided by the second example is the same as those provided by the first example.

According to this example, there are five unconstrained limbs, that is, the first limb L1, the second limb L2, the third limb L3, the fourth limb L4, and the fifth limb L5. The unconstrained limbs are divided into two categories of an upper limb and a middle limb. The upper limb comprises the first limb L1, and the second limb L2. The specific structure of each limb of the upper limb is shown in the drawings. The middle limb comprises the third limb L3, the fourth limb L4 and the fifth limb L5. The specific structure of each limb of the middle limb is shown in the drawings.

Two upper joints of the first limb L1 and the second limb L2 are circumferentially spacedly arranged at the first moving sub-platform 31 which is close to a head end of the motor spindle 2, and two lower joints of the first limb L1 and the second limb L2 are respectively connected with two protrusions protruding upwards from a circumference of the fixed base 1, so that the first limb L1 and the second limb L2 form a triangular shape. Three upper joints of the third limb L3, the fourth limb L4 and the fifth limb L5 are circumferentially spacedly arranged at the second moving sub-platform 32, and three lower joints of the third limb L3, the fourth limb L4 and the fifth limb L5 are circumferentially spacedly arranged at an end surface of the fixed base 1, that is, in the third limb L3, the fourth limb L4 and the fifth limb L5, every two adjacent limbs form a triangular shape, the three lower joints of the third limb L3, the fourth limb L4 and the fifth limb L5 also form a triangular shape. The second Hook joint U2 of the sixth limb is connected with the third moving sub-platform 33. A sliding base of the sixth limb L6 is opposite to the lower joint of the fifth limb L5, the two lower joints of the third limb L3 and the fourth limb L4 are symmetrically set relative to the sliding base of the sixth limb L6, and the two lower joints of the first limb L1 and the second limb L2 are also symmetrically set relative to the sliding base of the sixth limb L6.

The first sliding pair P1 of each of the first limb L1 and the second limb L2 has a hollow sleeve structure, and a retractable rod forming the first sliding pair P1 is always kept at a certain distance from the ground for avoiding collision interference.

### Third Example of First Embodiment

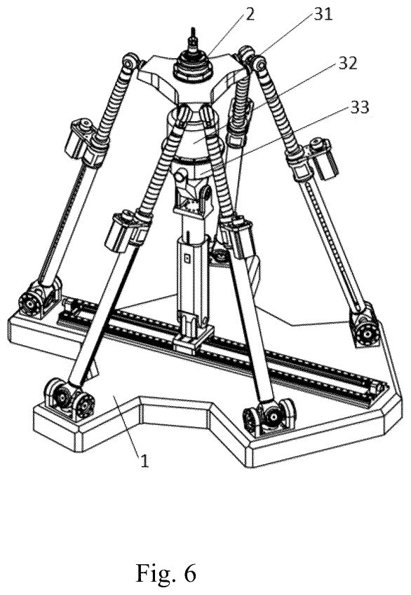

As shown in FIG. 6, a six-limb five-degree-of-freedom parallel machining robot is illustrated, the parallel machining robot provided by the third example is the same as that provided by the first example in form of motion, the structure of the kinematic pairs and the limbs provided by the third example is the same as those provided by the first example.

According to this example, there are five unconstrained limbs, that is, the first limb L1, the second limb L2, the third limb L3, the fourth limb L4, and the fifth limb L5. These five unconstrained limbs are same in structure and shown in the drawings. The first limb L1, the second limb L2, the third limb L3, and the fourth limb L4 are divided into two categories of A-group limb and B-group limb. The A-group limb comprises the first limb L1 and the second limb L2. The B-group limb comprises the third limb L3 and the fourth limb L4. Two upper joints of the first limb L1 and the second limb L2 are set at an outer wall of the first moving sub-platform 31 and are combined to be a set of connect joint. Two upper joints of the third limb L3 and the fourth limb L4 are set at the outer wall of the first moving sub-platform 31 and are combined to be another set of connect joint. An upper joint of the fifth limb L5 is independently set at the outer wall of the first moving sub-platform 31. The two sets of connect joint and the upper joint of the fifth limb L5 form a triangular shape. Five lower joints of the first limb L1, the second limb L2, the third limb L3, the fourth limb L4 and the fifth limb L5 are spacedly arranged on the fixed base 1. Every two adjacent limbs of these five limbs form a triangular shape. A top portion of the sixth limb L6 is connected with the third moving sub-platform 33, and a sliding base of the sixth limb L6 forms a center of a pattern which is defined by enclosing the lower joints of the unconstrained limbs.

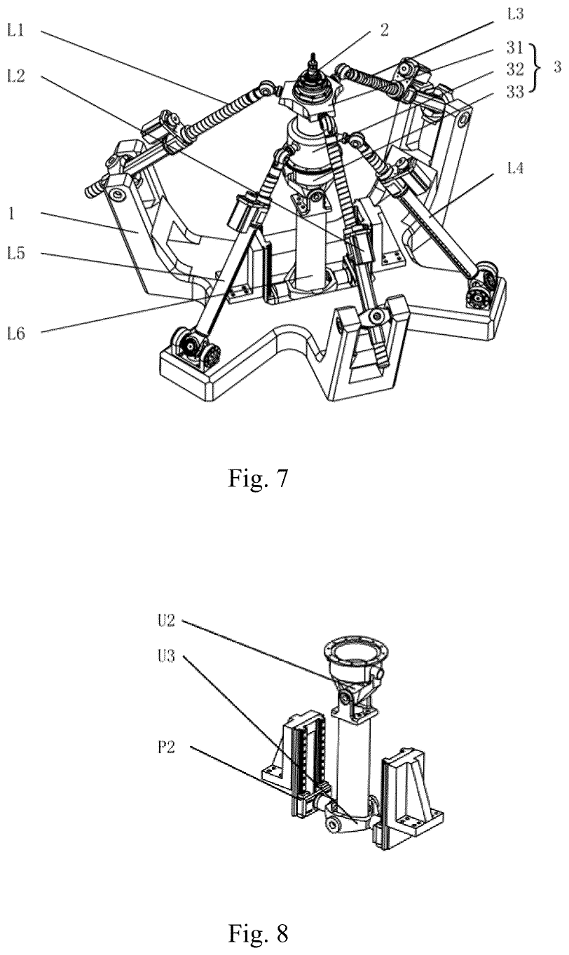

Referring to FIGS. 7 to 9, a six-limb five-degree-of-freedom parallel machining robot according to a second embodiment of the present invention is illustrated.

The parallel machining robot comprises a fixed base 1 as the basis of assembly, a limb group for pose adjustment, a moving platform 3 as output assembly, wherein a motor spindle 2 as an output unit is set in the moving platform 3, the limb group comprises an unconstrained limb sub-group and a sixth limb L6, the sixth limb L6 is connected with the fixed base 1 through a second sliding pair P2, and a movement direction of the second sliding pair P2 is perpendicular to an end surface of the fixed base 1.

The second sliding pair P2 comprises two support seats which are set on the fixed base 1, and two installation sides of the two support seats are opposite to each other. Two sliding units are respectively set on the installation sides of the two support seats for driving the sixth limb to move upwards and downwards along a direction which is perpendicular to the fixed base 1.

A third Hook joint U3 is set at a lifting end of the second sliding pair P2 and is movably connected with a limb rod.

An upper end of the limb rod is connected with a second Hook joint U2, and the second Hook joint U2 is movably connected with the moving platform 3.

The moving platform 3 comprises a first moving sub-platform 31, a second moving sub-platform 32 fixed with the first moving sub-platform 31, and a third moving sub-platform 33 fixed with the second moving sub-platform 32.

The second Hook joint U2 is movably connected with the third moving sub-platform 33.

The unconstrained limb sub-group comprises an upper limb and a middle limb, wherein a top portion of the upper limb, the middle limb and the sixth limb is in a three-layer connection with the moving platform 3 for the pose adjustment of the motor spindle 2.

The fixed base 1 has an assembly slot for being fitted with the second sliding pair P2.

Both the upper limb and the middle limb have a first sliding pair P1 capable of self-actuating expansion.

Specifically, the sixth limb L6 is configured to adjust a lower end of the moving platform 3, the unconstrained limb sub-group is configured to provide the joint support to an outer wall of the moving platform 3, and the sixth limb L6 and the unconstrained limb sub-group are combined to adjust the pose of the moving platform 3.

Specifically, the motor spindle 2 is fixed with the moving platform 3 for realizing the pose adjustment of the combination of the sixth limb L6 and the unconstrained limb sub-group on the motor spindle 2.

Specifically, each of the support seats has an L-shaped structure, and a lower end of the each of the support seats is connected with the fixed base 1 through flanges.

Specifically, a support rib plate is set at a back of the each of the support seats for ensuring the overall rigidity of the each of the support seats.

Specifically, on the basis of the sliding base, the second sliding pair P2 moves upwards and downwards, and the sliding base is perpendicular to the fixed base 1.

Specifically, the second Hook joint U2 of the sixth limb L6 is movably connected with the third moving sub-platform 33.

Specifically, one end of the upper limb is in joint connection with an outer wall of the first moving sub-platform 31, and another end of the upper limb is in joint connection with the fixed base 1.

Specifically, one end of the middle limb is in joint connection with an outer wall of the second moving sub-platform 32, and another end of the middle limb is in joint connection with the fixed base 1.

Specifically, the joint connection is spherical hinged connection or Hook joint connection.

Both the upper limb and the middle limb have a first sliding pair P1, and the first sliding pair is able to expand and contract along a length direction thereof.

Specifically, the sixth limb L6 is configured to adjust the lower end of the moving platform 3, the unconstrained limb sub-group is configured to provide the joint support to the outer wall of the moving platform 3, and the sixth limb L6 and the unconstrained limb sub-group are combined to adjust the pose of the moving platform 3. Specifically, the first moving sub-platform 31, the second moving sub-platform 32 and the third moving sub-platform 33 are separately fixed or integrally formed.

Specifically, the outer wall of the first moving sub-platform 31 and the outer wall of the second moving sub-platform 32 have assembly holes for assembling the upper limb and the middle limb respectively.

Specifically, the unconstrained limb sub-group comprises five unconstrained limbs, namely, the first limb L1, the second limb L2, the third limb L3, the fourth limb L4 and the fifth limb L5.

### First Example of Second Embodiment

Referring to FIGS. 7 and 8, a six-limb five-degree-of-freedom parallel machining robot is illustrated. The parallel machining robot comprises a fixed base 1, a motor spindle 2, a moving platform 3, a first limb L1, a second limb L2, a third limb L3, a fourth limb L4, a fifth limb L5 and a sixth limb L6.

Specifically, two ends of all of the first limb L1, the second limb L2, the third limb L3, the fourth limb L4, the fifth limb L5 and the sixth limb L6 are connected with the fixed base 1 and the moving platform 3, respectively. The moving platform 3 comprises a first moving sub-platform 31, a second moving sub-platform 32 and a third moving sub-platform 33, wherein every two adjacent moving sub-platforms are fixed with each other, and the motor spindle 2 is fixed in the moving platform 3, so that the five-degree-of-freedom parallel machining robot is formed.

Specifically, the unconstrained limb sub-group comprises five unconstrained limbs, namely, the first limb L1, the second limb L2, the third limb L3, the fourth limb L4 and the fifth limb L5. Each of the five unconstrained limbs comprises a first sliding pair P1, a spherical hinge 4 and a first Hook joint U1, wherein the first sliding pair P1 is set between the spherical hinge 4 and the first Hook joint U1.

Specifically, the sixth limb L6 comprises a second sliding pair P2, a second Hook joint U2 and a third Hook joint U3, wherein the third Hook joint U3 is set between the second sliding pair P2 and the second Hook joint U2.

Specifically, one end of the unconstrained limbs is connected with the fixed base 1 through the first Hook joint U1 or the spherical hinge 4, and accordingly, another end of the unconstrained limbs is connected with the moving platform 3 through the spherical hinge 4 or the first Hook joint U1; the first sliding pair P1 is arranged between the spherical hinge 4 and the first Hook joint U2; the sixth limb is a constrained limb, one end of the constrained limb is connected with the fixed base 1 through the second sliding pair P3, another end of the constrained limb is connected with the moving platform 3 through the second Hook joint U2.

Specifically, the first limb L1, the second limb L2, the third limb L3, the fourth limb L4 and the fifth limb L5 of the unconstrained limb sub-group are divided into two categories of an upper limb and a middle limb. The upper limb comprises the first limb L1, the second limb L2 and the third limb L3. The specific structure of each limb of the upper limb is shown in the drawings. The middle limb comprises the fourth limb L4 and the fifth limb L5. The specific structure of each limb of the middle limb is shown in the drawings. Three upper joints of the first limb L1, the second limb L2 and the third limb L3 are circumferentially spacedly arranged at the first moving sub-platform 31. Three lower joints of the first limb L1, the second limb L2 and the third limb L3 are respectively connected with three protrusions protruding upwards from a circumference of the fixed base 1. Every two adjacent limbs of the first limb L1, the second limb L2 and the third limb L3 form a triangular shape.

Two upper joints of the fourth limb L4 and the fifth limb L5 are circumferentially spacedly arranged at the second moving sub-platform 32, and two lower joints of the fourth limb L4 and the fifth limb L5 are circumferentially spacedly arranged at a lower portion of the fixed base 1. The fourth limb L4 and the fifth limb L5 form a triangular shape. One end of the sixth limb L6 is movably connected with the third moving sub-platform 33, and the second sliding pair P2 which is provided at another end of the sixth limb L6 is connected with the fixed base through the two support seats. The three lower joints of the first limb L1, the second limb L2 and the third limb L3 form a triangular shape. The triangular shape is symmetrical relative to an axis of the second sliding pair P2. The two lower joints of the fourth limb L4 and the fifth limb L5 are symmetrical to each other relative to the axis of the second sliding pair P2.

Specifically, the first limb L1, the second limb L2, the third limb L3, the fourth limb L4 and the fifth limb L5 are independently driven by a motor. The first sliding pair P1 of each of the first limb L1, the second limb L2, the third limb L3, the fourth limb L4 and the fifth limb L5 is independently driven by the motor for completing the stretching motion; the spherical hinge 4 and the first Hook joint U1 which are respectively connected with two ends of the first sliding pair P1 cooperate with the first sliding pair P1 for completing the predetermined pose of the moving platform 3. The second sliding pair P2 of the sixth limb L6 complete the sliding motion with the movement of the moving platform 3; the second Hook joint U2 and the third Hook joint U3 which are both set at one end of the second sliding pair P2 also cooperate with the second sliding pair P2 for achieving the corresponding motion under the predetermined pose of the moving platform 3, so as to realize the five-degree-of-freedom of the moving platform 3.

The first sliding pair P1 of each of the first limb L1, the second limb L2 and the third limb L3 has a hollow sleeve structure, and a retractable rod forming the first sliding pair P1 is always kept at a certain distance from the ground.

### Second Example of Second Embodiment

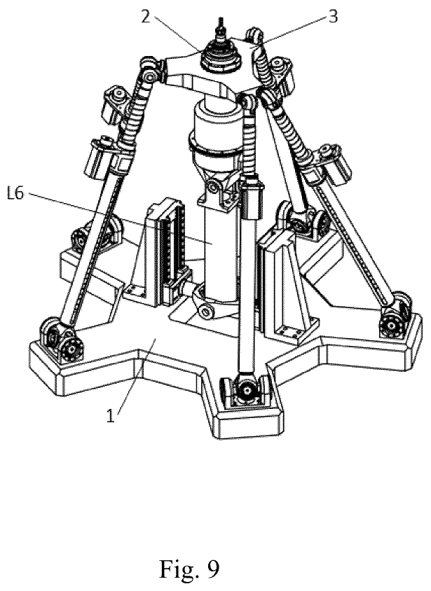

As shown in FIG. 9, a six-limb five-degree-of-freedom parallel machining robot is illustrated, the parallel machining robot according to the second example is the same as the parallel machining robot according to the first example in form of motion, the structure of the kinematic pairs and the limbs according to the second example is the same as those according to the first example.

According to this example, there are four unconstrained limbs, that is, the first limb L1, the second limb L2, the third limb L3 and the fourth limb L4. These four unconstrained limbs are divided into two categories of A-group limb and B-group limb. The A-group limb comprises the first limb L1 and the second limb L2. The B-group limb comprises the third limb L3 and the fourth limb L4. Two upper joints of the first limb L1 and the second limb L2 are set at an outer wall of the first moving sub-platform 31 and are combined to be a set of connect joint. Two upper joints of the third limb L3 and the fourth limb L4 are set at the outer wall of the first moving sub-platform 31 and are combined to be another set of connect joint. An upper joint of the fifth limb L5 is independently set at the outer wall of the first moving sub-platform 31. The two sets of connect joint and the upper joint of the fifth limb L5 form a triangular shape. Five lower joints of the first limb L1, the second limb L2, the third limb L3, the fourth limb L4 and the fifth limb L5 are circumferentially spacedly arranged on the fixed base 1. Every two adjacent limbs of the first limb L1, the second limb L2, the third limb L3, the fourth limb L4 and the fifth limb L5 form a triangular shape. A top portion of the sixth limb L6 is movably connected with the third moving sub-platform 33. The five lower joints of the first limb L1, the second limb L2, the third limb L3, the fourth limb L4 and the fifth limb L5 form a pentagonal shape. A lower portion of the sixth limb L6 passes through the pentagonal shape to be connected with the fixed base.

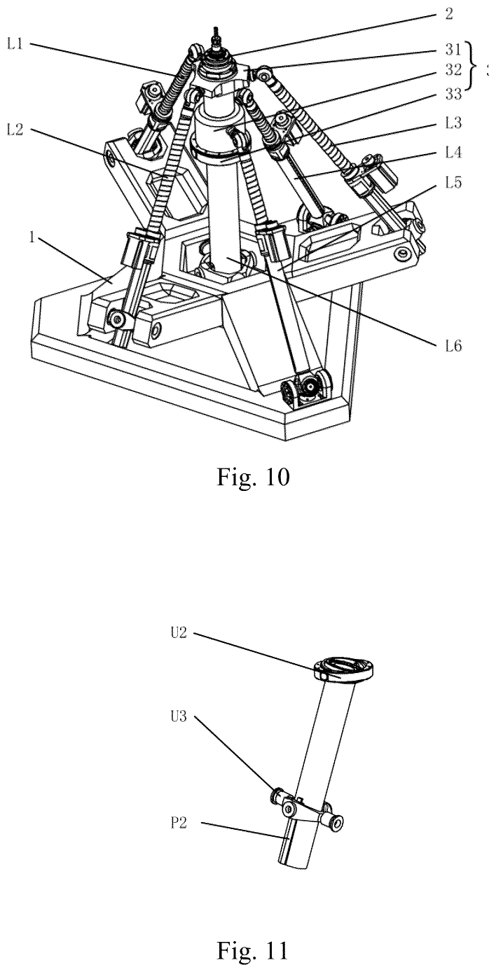

A six-limb five-degree-of-freedom parallel machining robot according to a third embodiment of the present invention is illustrated, as shown in FIGS. 10 to 15.

The parallel machining robot comprises a fixed base 1 as the basis of assembly, a limb group for pose adjustment, a moving platform 3 as output assembly, wherein a motor spindle 2 as an output unit is set in the moving platform 3, the limb group comprises an unconstrained limb sub-group and a sixth limb L6, the sixth limb L6 is movably connected with the fixed base 1 through a third Hook joint U3, and the sixth limb L6 rotates at an angle with the fixed base 1.

The fixed base 1 has a rotation fit structure to provide support for rotation of the sixth limb L6.

The third Hook joint U3 is connected with a retractable end of a second sliding pair P2, and the second sliding pair P2 is set in a limb rod.

A second Hook joint U2 is set at a top portion of the limb rod and is movably connected with the moving platform 3.

The moving platform 3 comprises a first moving sub-platform 31, a second moving sub-platform 32 fixed with the first moving sub-platform 31, and a third moving sub-platform 33 fixed with the second moving sub-platform 32.

The second Hook joint is movably connected with the third moving sub-platform 33.

The unconstrained limb sub-group comprises an upper limb and a middle limb, wherein a top portion of each of the upper limb, the middle limb and the sixth limb L6 is in three-layer connection with the moving platform 3, so as to realize the pose adjustment of a motor spindle 2.

Each of the upper limb and the middle limb has a first sliding pair P1 which is retractable.

The first sliding pair P1 is driven by a motor through a synchronous belt to drive a ball screw.

The second sliding pair P2 is able to slide with the pose adjustment of the moving platform 3, for controlling the unconstrained limbs of the unconstrained limb sub-group to extend and contract under the constraint of the sixth limb L6, so that the five-degree-of-freedom motion of the moving platform 3 is achieved.

Specifically, the sixth limb L6 is configured to adjust a lower end of the moving platform 3, the unconstrained limb sub-group is configured to provide the joint support to an outer wall of the moving platform 3, and the sixth limb L6 and the unconstrained limb sub-group are combined to adjust the pose of the moving platform 3.

Specifically, the motor spindle 2 is fixed with the moving platform 3 for realizing the pose adjustment of the combination of the sixth limb L6 and the unconstrained limb sub-group on the motor spindle 2.

Specifically, an outer wall of the limb rod has a guide groove, a stretching connection portion capable of sliding is set in the guide groove, and the third Hook joint U3 is connected with the stretching connection portion.

Specifically, the fixed base 1 comprises an installation seat, the third Hook joint U3 is movably connected with the installation seat, so that the sixth limb L6 rotates at an angle with the fixed base 1.

Specifically, one end of the upper limb is in joint connection with an outer wall of the first moving sub-platform 31, and another end of the upper limb is in joint connection with the fixed base 1.

Specifically, one end of the middle limb is in joint connection with an outer wall of the second moving sub-platform 32, and another end of the middle limb is in joint connection with the fixed base 1.

Specifically, the joint connection is spherical hinged connection or Hook joint connection.

Each of the upper limb and the middle limb has the first sliding pair P1 which is capable of extend and contract along a length direction.

Specifically, the sixth limb L6 is configured to adjust the lower end of the moving platform 3, the unconstrained limb sub-group is configured to provide the joint support to the outer wall of the moving platform 3, and the sixth limb L6 and the unconstrained limb sub-group are combined to adjust the pose of the moving platform 3. Specifically, the first moving sub-platform 31, the second moving sub-platform 32 and the third moving sub-platform 33 are separately fixed or integrally formed.

Specifically, the outer wall of the first moving sub-platform 31 and that of the second moving sub-platform 32 have assembly holes for being fitted with the upper limb and the middle limb, respectively.

Specifically, the unconstrained limb sub-group comprises five unconstrained limbs, that is, the first limb L1, the second limb L2, the third limb L3, the fourth limb L4 and the fifth limb L5.

### First Example of Third Embodiment

Referring to FIGS. 10 and 11, a six-limb five-degree-of-freedom parallel machining robot is illustrated. The parallel machining robot comprises a fixed base 1, a motor spindle 2, a moving platform 3, a first limb L1, a second limb L2, a third limb L3, a fourth limb L4, a fifth limb L5 and a sixth limb L6.

Specifically, two ends of all of the first limb L1, the second limb L2, the third limb L3, the fourth limb L4, the fifth limb L5 and the sixth limb L6 are connected with the fixed base 1 and the moving platform 3, respectively. The moving platform 3 comprises a first moving sub-platform 31, a second moving sub-platform 32 and a third moving sub-platform 33, wherein every two adjacent moving sub-platforms are fixed with each other, and the motor spindle 2 is fixed in the moving platform 3, so that the multiple-limb five-degree-of-freedom parallel machining robot is formed.

Specifically, there are five unconstrained limbs, namely, the first limb L1, the second limb L2, the third limb L3, the fourth limb L4 and the fifth limb L5. Each of the five unconstrained limbs comprises a first sliding pair P1, a spherical hinge 4 and a first Hook joint U1, wherein the first sliding pair P1 is arranged between the spherical hinge 4 and the first Hook joint U1.

Specifically, the sixth limb L6 comprises a second sliding pair P2, a second Hook joint U2 and a third Hook joint U3, wherein the second sliding pair P2 is set between the second Hook joint U2 and the third Hook joint U3.

Specifically, upper joints of the unconstrained limbs are movably connected with the moving platform 3, lower joints of the unconstrained limbs are movably connected with the fixed base 1, a top portion of the sixth limb L6 is movably connected with the moving platform 3, and a bottom portion of the sixth limb L6 is movably connected with the fixed base 1.

Specifically, the five unconstrained limbs are divided into two categories of an upper limb and a middle limb. The upper limb comprises the first limb L1, the second limb L2 and the third limb L3. The specific structure of each limb of the upper limb is shown in the drawings. The middle limb comprises the fourth limb L4 and the fifth limb L5. The specific structure of each limb of the middle limb is shown in the drawings. Three upper joints of the upper limb are circumferentially spacedly arranged at the first moving sub-platform 31. Three lower joints of the upper limb are respectively connected with three installation seats at a circumference of the fixed base 1. The installation seats are spacedly arranged and inclined upwards. Accordingly, every two adjacent limbs of the first limb L1, the second limb L2 and the third limb L3 form a triangular shape. Two upper joints of the fourth limb L4 and the fifth limb L5 are circumferentially spacedly arranged at the second moving sub-platform 32, and two lower joints of the fourth limb L4 and the fifth limb L5 are circumferentially spacedly arranged at a lower portion of the fixed base 1. The fourth limb L4 and the fifth limb L5 form a triangular shape. The sixth limb L6 is movably connected with the third moving sub-platform 33, and the sixth limb L6 forms a center of a pattern which is defined by enclosing the lower joints of the unconstrained limbs.

In this example, the second Hook joint U2 or the third Hook joint U3 has a hollow structure, the second sliding pair P2 has a hollow cylindrical structure, and wires of the motor spindle 2 are able to be set in the moving platform and the sixth limb L6.

Specifically, the first limb L1, the second limb L2, the third limb L3, the fourth limb L4 and the fifth limb L5 are independently driven by the motor. The first sliding pair P1 of each of the first limb L1, the second limb L2, the third limb L3, the fourth limb L4 and the fifth limb L5 is able to be independently driven to complete the stretching motion. The spherical hinge 4 and the first Hook joint U1 respectively connected with two ends of the first sliding pair P1 cooperate with the first sliding pair P1 to complete the predetermined pose of the moving platform 3. The second sliding pair P2 of the sixth limb L6 completes the sliding motion with the movement of the moving platform 3. The second Hook hinge U2 and the third Hook hinge U3 respectively connected with two ends of the second sliding pair P2 also cooperate with the second sliding pair P2 to complete the predetermined pose of the moving platform 3. As a result, the five-degree-of-freedom of the moving platform 3 is achieved.

The first sliding pair P1 of each of the first limb L1, the second limb L2 and the third limb L3 has a hollow sleeve structure, and a retractable rod forming the first sliding pair P1 is always kept at a certain distance from the ground.

Specifically, the rotation fit structure is a hollow installation frame which is located at a center of three installation seats, the fixed base 1 comprise a support body, the lower joints of the fourth limb L4 and the fifth limb L5 are set on the support body.

More specifically, the support body and the installation frame are connected with each other through an inclined connecting plate, and the installation frame is configured to provide the rotation space for the sixth limb L6.

### Second Example of Third Embodiment

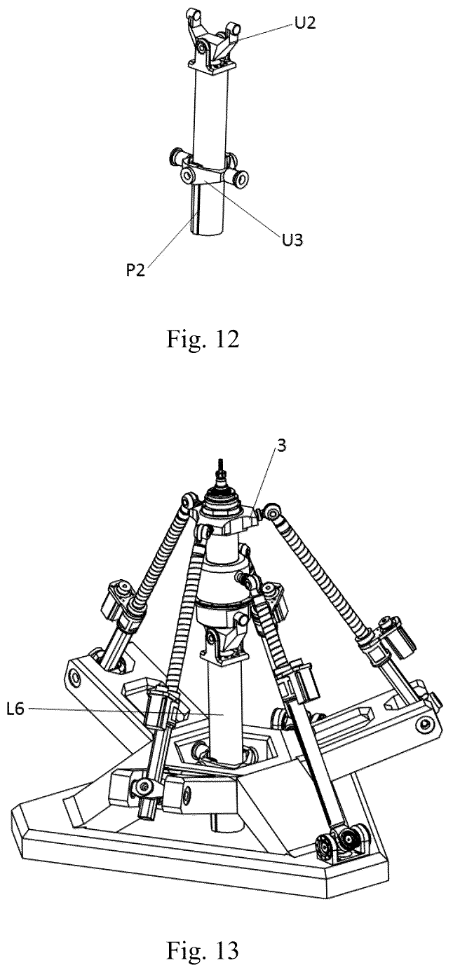

As shown in FIGS. 12 and 13, a six-limb five-degree-of-freedom parallel machining robot is illustrated, the parallel machining robot according to the second example is the same as the parallel machining robot according to the first example in form of motion, the structure of the kinematic pairs and the limbs according to the second example is the same as those according to the first example.

In this example, the sixth limb L6 comprises two rotation joints, namely, a second Hook joint U2 and a third Hook joint U3. The joint for connecting the sixth limb L6 with the moving platform 3 is an upper joint. The joint for connecting the sixth limb 6 with the fixed base 1 is a lower joint. A rotation axis of the upper joint is spatially vertical to that of the lower joint, that is, two hinged axes of the upper joint and the lower joint are always vertically staggered. Due to the structure of the second Hook joint U2 or the third Hook joint U3, the motor spindle 2 needs to drill holes in a side wall of the moving platform 3 for routing.

The first sliding pair P1 of each of the first limb L1, the second limb L2 and the third limb L3 has a hollow sleeve structure, and a retractable rod forming the first sliding pair P1 is always kept at a certain distance from the ground.

### Third Example of Third Embodiment

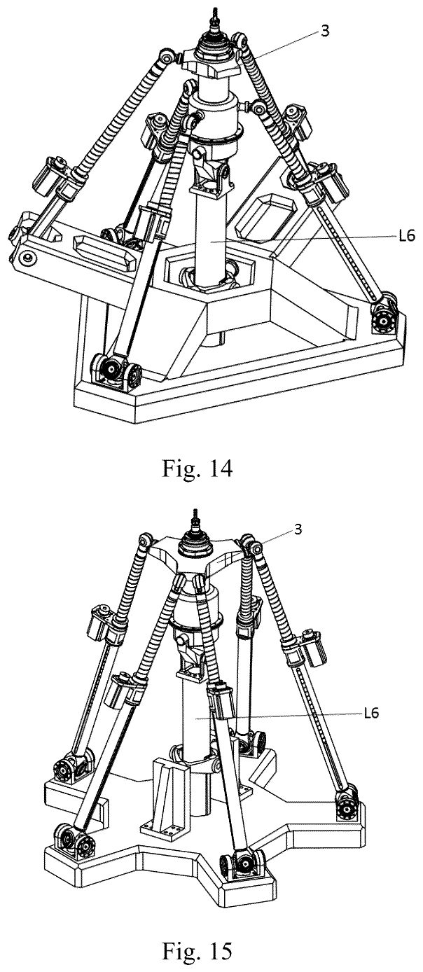

As shown in FIG. 14, a six-limb five-degree-of-freedom parallel machining robot is illustrated, the parallel machining robot according to the third example is the same as the parallel machining robot according to the first example in mode of motion, the structure of the kinematic pairs and the limbs according to the third example is the same as those according to the first example.

Specifically, the first limb L1, the second limb L2, the third limb L3, the fourth limb L4 and the fifth limb L5 are divided into two categories of an upper limb and a middle limb. The upper limb comprises the first limb L1 and the second limb L2. The specific structure of each limb of the upper limb is shown in the drawings. The middle limb comprises the third limb L3, the fourth limb L4 and the fifth limb L5. The specific structure of each limb of the middle limb is shown in the drawings. Two upper joints of the first limb L1 and the second limb L2 are circumferentially spacedly arranged at the first moving sub-platform 31. Two lower joints of the first limb L1 and the second limb L2 are respectively connected with two installation seats which are extended upwards at a circumference of the fixed base 1. The first limb L1 and the second limb L2 form a triangular shape. Three upper joints of the third limb L3, the fourth limb L4 and the fifth limb L5 are circumferentially spacedly arranged at the second moving sub-platform 32, and three lower joints of the third limb L3, the fourth limb L4 and the fifth limb L5 are circumferentially spacedly arranged at a lower portion of the fixed base 1. Accordingly, every two adjacent limbs of the middle limb form a triangular shape. The three lower joints of the third limb L3, the fourth limb L4 and the fifth limb L5 on the fixed base 1 form a triangular shape. A lower portion of the sixth limb L6 passes through a center of a pattern which is defined by enclosing the five lower joints of the unconstrained limbs.

The first sliding pair P1 of each of the first limb L1 and the second limb L2 has a hollow sleeve structure, and a retractable rod forming the first sliding pair P1 is always kept at a certain distance from the ground.

### Fourth Example of Third Embodiment

As shown in FIG. 15, a six-limb five-degree-of-freedom parallel machining robot is illustrated, the parallel machining robot according to the fourth example is the same as the parallel machining robot according to the first example in form of motion, the structure of the kinematic pairs and the limbs according to the fourth example is the same as those according to the first example.

In this example, five unconstrained limbs are same in structure, and the structure of each of the five unconstrained limbs is shown in the drawings.

Four of the five unconstrained limbs, namely, the first limb L1, the second limb L2, the third limb L3 and the fourth limb L4 are divided into two categories of A-group limb and B-group limb. The A-group limb comprises the first limb L1 and the second limb L2. The B-group limb comprises the third limb L3 and the fourth limb L4. Two upper joints of the first limb L1 and the second limb L2 are set at an outer wall of the first moving sub-platform 31 and are combined to be a set of connect joint. Two upper joints of the third limb L3 and the fourth limb L4 are set at the outer wall of the first moving sub-platform 31 and are combined to be another set of connect joint. An upper joint of the fifth limb L5 is independently set at the outer wall of the first moving sub-platform 31. The two sets of connect joint and the upper joint of the fifth limb L5 form a triangular shape.

Five lower joints of the first limb L1, the second limb L2, the third limb L3, the fourth limb L4 and the fifth limb L5 are circumferentially spacedly arranged at the fixed base 1. Every two adjacent unconstrained limbs form a triangular shape. A top portion of the sixth limb L6 is movably connected with the third moving sub-platform 32. The five lower joints of the first limb L1, the second limb L2, the third limb L3, the fourth limb L4 and the fifth limb L5 are at a same plane. A lower portion of the sixth limb L6 passes through a central axis of a pattern which is defined by enclosing the five lower joints.

The basic principles, main features, and beneficial effects of the present invention are described above, and several specific embodiments of the present invention are also shown. Any changes, modifications, substitutes, and variations to these embodiments without deviating from the purpose of the present invention are within the scope of the claims of the present invention.

What is claimed is:

1. A six-limb five-degree-of-freedom parallel machining robot, the parallel machining robot comprising: a fixed base (1) as basis of assembly, a limb group for pose adjustment, and a moving platform (3) as output assembly, wherein a motor spindle (2) as an output unit is set in the moving platform (3); the limb group comprises an unconstrained limb sub-group and a sixth limb movably connected with the fixed base (1).

2. The six-limb five-degree-of-freedom parallel machining robot according to claim 1, wherein the moving platform (3) comprises a first moving sub-platform (31), a second moving sub-platform (32) fixed with the first moving sub-platform (31), and a third moving sub-platform (33) fixed with the second moving sub-platform (32).

3. The six-limb five-degree-of-freedom parallel machining robot according to claim 2, wherein the unconstrained limb sub-group comprises an upper limb and a middle limb, a top portion of all of the upper limb, the middle limb and the sixth limb is in a three-layer connection with the moving platform (3) for pose adjustment of the motor spindle (2).

4. The six-limb five-degree-of-freedom parallel machining robot according to claim 3, wherein one end of the upper limb is in joint connection with an outer wall of the first moving sub-platform (31), and another end of the upper limb is in joint with the fixed base (1).

5. The six-limb five-degree-of-freedom parallel machining robot according to claim 3, wherein one end of the middle limb is in joint connection with an outer wall of the second moving sub-platform (32), and another end of the middle limb is in joint connection with the fixed base (1).

6. The six-limb five-degree-of-freedom parallel machining robot according to claim 3, wherein the joint connection is spherical hinged connection or Hook joint connection.

7. The six-limb five-degree-of-freedom parallel machining robot according to claim 3, wherein both of the upper limb and the middle limb have a first sliding pair, and the first sliding pair is able to drive the upper limb or the middle limb to extend and contract along a length direction thereof.

8. The six-limb five-degree-of-freedom parallel machining robot according to claim 1, wherein the sixth limb is connected with the fixed base (1) through a third sliding pair, and a moving direction of the third sliding pair is parallel to the fixed base (1);
the sixth limb has a first revolute pair, an axial direction of a rotation shaft of the first revolute pair is parallel to the moving direction of the third sliding pair;
the sixth limb has a second sliding pair, one end of the second sliding pair is connected with the first revolute pair, and another end of the second sliding pair is connected with a second Hook joint.

9. The six-limb five-degree-of-freedom parallel machining robot according to claim 1, wherein the sixth limb is connected with the fixed base (1) through the second sliding pair, and a moving direction of the second sliding pair is perpendicular to an end plane of the fixed base (1);
the second sliding pair comprises a pair of support seats which are set on the fixed base (1), and two installation sides of the pair of support seats are opposite to each other;
two sliding bases are respectively set at the two installation sides of the pair of support seats, two sliding units are respectively set on the two sliding bases and are capable of moving upwards and downwards along the two sliding bases, and the sliding units drive the sixth limb to move upwards and downwards in a direction perpendicular to the fixed base (1).

10. The six-limb five-degree-of-freedom parallel machining robot according to claim 1, wherein the sixth limb is movably connected with the fixed base (1) through a third Hook joint, and the sixth limb rotates at an angle with the fixed base (1);
the fixed base (1) has a rotation fit structure to provide support for rotation of the sixth limb;
the third Hook joint is connected with a retractable end of the second sliding pair, and the second sliding pair is set in a limb rod.
